(19) United States
(12) Patent Application Publication
(10) Pub. No.: US 2024/0375308 A1
(43) Pub. Date: Nov. 14, 2024

(54) METHOD FOR PRODUCING LONGER SLICING PRODUCTS AND CUTTING MACHINE FOR CUTTING THESE SLICING PRODUCTS

(71) Applicant: MULTIVAC SEPP HAGGENMÜLLER SE & CO. KG, Wolfertschwenden (DE)

(72) Inventor: Manfred ACHENBACH, Biedenkopf (DE)

(73) Assignee: MULTIVAC SEPP HAGGENMÜLLER SE & CO. KG, Wolfertschwenden (DE)

(21) Appl. No.: 18/659,790

(22) Filed: May 9, 2024

(30) Foreign Application Priority Data
May 11, 2023 (DE) 102023112461.7

(51) Int. Cl. B26D 7/08; A01J 27/00; A23B 4/07; A23C 19/097; A23L 13/60; A23P 30/10; B26D 7/32

(52) U.S. Cl. CPC B26D 7/08; A01J 27/00; A23B 4/07; A23C 19/0976; A23L 13/65; A23P 30/10; B26D 7/32; B26D 2210/02

(57) ABSTRACT

To minimize the frequency of losses in the form of product tailpieces, which cannot be sliced because of gripper claws located therein, long or endless products are produced, whether outside or inside the cutting machine, by positioning product parts adjacently in lengthwise direction one behind another and joining mutually facing end faces of these product parts. The product parts may be joined outside the machine, resulting in long but finite products, or by positioning within the machine and on a feed belt a new product part in each case in succession at the rear end of the product currently being sliced and joining the new product part to the rear end of the rearmost product part of the previous product to form a virtually endless product.

### CROSS-REFERENCE TO RELATED APPLICATIONS

This application claims foreign priority benefits under 35 U.S.C. § 119 (a)-(d) to German patent application number DE 102023112461.7, filed May 11, 2023, which is hereby incorporated herein by reference in its entirety.

### TECHNICAL FIELD

The disclosure relates to cutting machines, in particular slicers, which can be used in the food processing industry to slice slabs of an only slightly compressible product such as sausage or cheese.

### BACKGROUND

These slabs may be produced with a cross-section which retains its shape and dimensions well over its length, i.e., is substantially constant, and are also known as slicing products.

Multiple slicing products arranged parallel adjacent one another are usually sliced simultaneously, with one and the same blade, which moves in the direction perpendicular to the lengthwise direction of the slicing product, in each case cutting off one slice in one pass. The following is based on the above scenario, without the disclosure being limited to such multi-lane slicers.

The slicing products are pushed forward by a feed conveyor of a feed unit toward the blade of the cutting unit, in general on a downwardly inclined feed conveyor, and each fed through the product openings in a plate-shaped “cutting frame”, at the front end of which the protruding part of the slicing product is severed as a slice by the blade directly in front of the cutting frame.

The slices generally fall onto a discharge conveyor of a discharge conveyor unit, by means of which it is conveyed away for further processing.

During slicing, the slicing products are usually held at their rear end remote from the cutting frame by a gripper, which is provided to this end with corresponding gripper claws.

To reload the slicer with new slicing products, the feed conveyor may be folded down from the inclined slicing position into a generally horizontal loading position for simpler loading.

This may be performed while the rest of the slicing products, held by the grippers and a driven “top” and “bottom” product guide arranged generally directly upstream of the cutting frame, is still being sliced to completion.

Once this has taken place, the no longer sliceable tailpiece (since further slicing would cause the blade to impact the gripper claws situated in the tailpiece) is removed from the grippers.

The grippers then travel away from the cutting unit into their starting position maximally spaced therefrom, such that when the feed conveyor, reloaded with slicing products, is subsequently swiveled up, the grippers are again situated behind the rear ends of the new slicing products and can grasp them.

The problem is that the 15 to 20 millimeter long tailpiece represents a commercial loss for the manufacturer.

Slicing machines therefore exist in which the gripper and the gripper claws are detached from the tailpiece in good time before they can collide with the blade and the tailpiece then continues to be guided solely by the top and bottom product guide (in each case an endless, drivable traction belt on the top and bottom of the slicing product), the contact surface between product guide and tailpiece in the feed direction, however, being short, at just 10 to 20 millimeters.

The retention force in the feed direction alone is therefore as a rule no longer sufficient to feed the tailpiece in a controlled manner to the cutting unit, such that the tailpiece is often pulled wholly or partly out of the product opening in the cutting frame by the blade during slicing of said tailpiece and at any rate is sliced in an uncontrolled manner.

As the tailpieces are of a constant length, the commercial loss resulting from the tailpiece is greater, the shorter is the slicing product being processed. Especially with short slicing products, such as for instance dried or smoked bacon to be sliced, which is generally only 30 to 40 centimeters long, the 15 to 20 mm long tailpieces have a disproportionately significant effect.

### SUMMARY

It is therefore the object of the disclosure to provide a method for operating a cutting machine, in particular a slicer, which minimizes such losses in the form of tailpieces.

Said object is achieved by the features of claims 1 and 11. Advantageous embodiments are revealed by the subclaims.

All statements made below about the device according to the disclosure also apply to the method according to the disclosure and vice versa.

With regard to the method for manufacturing shingle-sliced or stacked portions from one or more slices severed from a slicing product using a cutting machine such as a slicer, which conventionally comprises
a cutting unit,
a feed unit for feeding at least one slicing product to the cutting unit,
a discharge conveyor unit with at least one portioning belt,
a controller for controlling moving parts of the cutting machine,

this object is achieved in that the slicing product is joined together prior to slicing from a plurality of slicing product parts adjoining one another in the feed direction, to produce the slicing product by joining the mutually facing end faces of the slicing product parts.

This results in a slicing product to be sliced which is longer by a multiple than the individually produced slicing product parts, so meaning that the percentage loss in the form of the tailpiece, which thus does not arise for each slicing product part but just once for the entire slicing product, is commensurately lower.

The slicing product parts are preferably joined together by freezing or adhesive bonding.

In the case of adhesive bonding, a food-safe adhesive is used which preferably consists of a substance which is present anyway in the slicing product to be sliced, for example fat, animal protein or the like.

If the slicing parts are to be joined together by freezing, the cold required for this purpose must either be supplied in the joint region or be already present (as it were as a heat sink), in particular stored in the end regions of the slicing product parts adjoining one another at that point. The term “cold” will be used below even though the term “heat sink” would be the physically correct term.

If the slicing product parts are not deep-frozen (i.e., frozen at least in their peripheral outer edge regions, which is almost always selected for slicing), the required cold must be supplied and freezing-together of the slicing product parts in the joint region carried out until the joint region has also been sliced.

To this end, cold is supplied in the form of a supplied cold gas such as air at a temperature markedly below 0° C. or indeed a liquid with a temperature markedly below 0° C.

Preferably, a liquid is selected which, on subsequent heating, is converted into a gas at a temperature which is still well below 0° C. and volatilized, such that no residue thereof remains in the slicing product. This may for example be brought about by supplying liquid nitrogen in the joint region, i.e., in particular onto the end faces to be frozen together.

The end faces then freeze solidly together at a temperature of around −150° C., which is generally sufficient to ensure that, starting with this temperature, the temperature in the joint region, which rises due to ambient heat, is still below 0° C. when the joint region is sliced.

Cold is therefore supplied, and in particular the entire freezing-together joining process is carried out, as short a time as possible before slicing of the joint region.

If the slicing product is prefrozen anyway, i.e., frozen at least in its outer peripheral layers in all spatial directions, it is sufficient, in the region of the contact faces, i.e., the mutually facing end faces, to start to thaw these frozen end regions somewhat and then bring these frozen end regions into contact with one another.

Then the heat introduced for thawing will spread into the slicing product, causing the temperature of the end faces to fall below 0° C. in the contact region and the slicing products to freeze together.

However, the temperature in the joint region is then generally higher than the temperature to which the peripheral regions of the slicing product parts were previously frozen, it thus being at most −40° C. and generally only −20° C.

Temperatures such as those which can be achieved by introducing liquid nitrogen are not feasible in this way and thus the time available until the joint region is cut is correspondingly shorter, such that such freezing-together by means of thawing should take place as directly as possible prior to feed of the joint region to the cutting unit, i.e., close to the cutting frame.

The end faces in the joint region may correspondingly be thawed by warm air, or indeed by applying steam or appropriately warm water, wherein the latter is deprecated in the case of foodstuffs because it means supplying a substance which was not originally present in the product, even if water is naturally also present in the product itself.

In principle, there are two options for where the joining process is carried out.

The first option is joining within the cutting machine itself.

In this case, the slicing product to be sliced, which consists of successive slicing product parts in the feed direction, may be continuously extended at the rear end by repeatedly positioning a new slicing product part against the rear end of the previous slicing product during slicing of the front end of the slicing product (which is not necessarily the same slicing product part as the one against which the next slicing product part is being positioned).

This is the ideal solution in terms of saving on tailpieces, because then absolutely no more tailpieces created by penetration of the gripper claws are lost.

The difficulty lies in the fact that positioning of a new slicing product part against the existing slicing product has to be carried out while the existing slicing product continues to advance in the feed direction due to the slicing process.

However, with today's slicers slicing is generally carried out while the feed device is arranged inclined sharply forward and downward toward the cutting unit at an angle of around 45°, so as to make use of gravity to feed the slicing product to the cutting unit and avoid stretching effects.

A new, long slicing product is therefore placed as a rule on the feed belt of the feed unit when the latter is folded down in the roughly horizontal loading position, and then the feed belt is folded up into the slicing position with the new slicing product located thereon.

Since this is not really possible in the case of continuous extension of the slicing product at the rear end, it should be carried out in the horizontal position or in a slicing position which is inclined only slightly forward and downward.

The second option involves joining a plurality of slicing product parts into a (finite) slicing product prior to introduction into the cutting machine, which is simpler than in the machine since outside the machine the slicing product parts can be joined together when stationary, whereas in the machine the joint region is moving along toward the cutting unit during slicing.

However, a tailpiece then arises for each of the finite slicing products.

If the slicing products are prefrozen, which generally takes place prior to introduction into the cutting machine, the individual slicing product parts may be arranged one behind the other arranged while still unfrozen, such that they freeze together automatically on freezing. This may additionally be assisted by appropriate contact pressure in the lengthwise direction, especially when the product parts still contain sufficient moisture, which then tends to exit from each of the end faces and promote freezing-together of the end faces.

One particularly disadvantageous product in terms of percentage tailpiece loss is bacon, i.e., pieces of dried and/or smoked ham or belly pork which contain very little moisture and in particular also have relatively small dimensions, being in generally only 30-40 cm long even in their direction of greatest extent meaning that a tailpiece of 15-20 mm in length is commercially particularly disadvantageous.

Such bacon pieces are generally also very uneven in shape, due to the drying and/or smoking, i.e., they are crooked in terms of cross-section and uneven in terms of their outer faces, including their end faces.

To produce bacon slices therefrom which visually look approximately identical, precisely such bacon pieces, but also other products, are frequently pressed into a somewhat more uniform shape prior to slicing, for example a cross-section which is constant over the length or in particular even predetermined, with substantially planar outer faces.

This may be done prior to prefreezing or together with prefreezing in a pressing mold in which such a product is precompressed in the lengthwise direction, i.e., the subsequent feed direction, and/or in at least one of the two transverse directions.

Precisely such a bacon piece generally also does not have an ideally planar end face for mutual adhesive bonding or freezing-together. It may therefore be sensible to sever a thin slice from the uneven end face prior to joining in particular of such bacon pieces to level said face and so enlarge the contact surface and facilitate mutual joining.

If, however, joining is carried out prior to or together with prefreezing of the slicing products, uneven end faces placed against one another may even be advantageous, especially if they are pressed together with preloading and this preloading is maintained during joining, in particular freezing-together, such that the uneven end faces then adapt to one another and interlock in places, so enlarging at least the contact faces of the two slicing product parts and thus the joint surface area.

Depending on the type of joint, for example depending on whether a substance from the joining process remains at the joint in the slicing product which was not originally present in the slicing product part, slices produced from the joint region of the slicing product are removed and not put to further use. This preferably takes place before the corresponding slices are placed on the portioning belt.

The reason for this is that the objective is to remove and make no further use of only individual slices from the joint region and not a whole portion, of which possibly just one or a few slices originate from the joint region.

With regard to a cutting machine which can be used to carry out the described method and has the above-described units, the relevant object is achieved in that the cutting machine comprises a joining device for joining the end faces of slicing product parts arranged in succession in the feed direction.

This joining device may be arranged within the base frame of the cutting machine or indeed be located outside it as a separate part not connected to the base frame.

In this way, the slicing product part may be made into a significantly longer overall slicing product, whether outside or once already within the cutting machine.

Accordingly, the joining device, if arranged within the machine, may preferably be part of the feed unit or in particular the gripper carriage thereof.

Preferably, a joining device arranged in the cutting machine may be configured to be movable, in particular synchronously, together with the slicing products to be fed during cutting.

The cutting machine may preferably comprise a prepressing device and/or a prefreezing device, which may also be positioned separately and away from the base frame of the cutting machine.

According to the disclosure, the joining device is then part of the prefreezing device or in particular a combined prefreezing and prepressing device, in which the individual slicing product is pressed into a more uniform shape and/or prefrozen at its peripheral layers ready for slicing.

In this way in particular, the pressing force needed for prepressing, in particular in the lengthwise direction (the subsequent feed direction), may be used for particularly firm and durable joining together of the slicing product parts.

A joining device preferably comprises an injecting element, with which either an adhesive or an auxiliary freezing agent can be introduced into the joint region, i.e., in particular between the end faces, approaching each other until they come into contact, of two successive slicing product parts.

The for example plate-shaped injecting element may be inserted, transversely of the feed direction, in between these two end faces and withdrawn again.

An auxiliary freezing agent is understood to mean an agent which either delivers the required cold to the joint but does not itself remain there or only to the slightest possible extent, such as for instance liquid nitrogen or a material which is introduced in liquid form but then itself freezes and serves, as it were, as a frozen adhesive when the slicing product parts are in the frozen-together state.

An adhesive, on the other hand, is understood to mean a substance which, even at ambient temperature, i.e., about 20° C., brings about adhesive bonding of the slicing product parts.

If joining is carried out within the actual cutting machine, i.e., within the feed unit, the feed belt preferably exhibits no or only slight inclination forward and downward toward the cutting unit, in particular of under 20°, preferably under 10°, so making it easier to feed further slicing product parts and position them against the rear end of the slicing product lying on the feed belt and to join them while product parts are moving forward and being sliced.

### BRIEF DESCRIPTION OF THE DRAWINGS

Embodiments according to the disclosure are described in greater detail below by way of example. In the drawings:

FIGS. 1A, B show a cutting machine in the form of a slicer according to the prior art in different perspective views, with feed belt folded up into the slicing position;

FIG. 2A shows a simplified side view of the cutting machine, with casing parts removed so that the individual conveyor belts loaded with a slicing product are more readily visible;

FIG. 2B is a side view according to FIG. 2A but with the feed belt folded down into the loading position and a slicing product sliced as far as a residue thereof;

FIGS. 3A-C shows, in plan view, longitudinal section and rear view, a separate prepressing device with three slicing product parts lying successively therein in the unpressed state;

FIGS. 4A-C shows, in plan view, longitudinal section and rear view, the prepressing device with three slicing product parts lying therein in the pressed, frozen-together state;

FIG. 5A-C show a cutting machine in side view according to FIG. 2A but with the feed belt less inclined; and

FIGS. 6A-F show the process of joining a new slicing product part in the cutting machine of FIGS. 5A-C in enlarged detail views.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

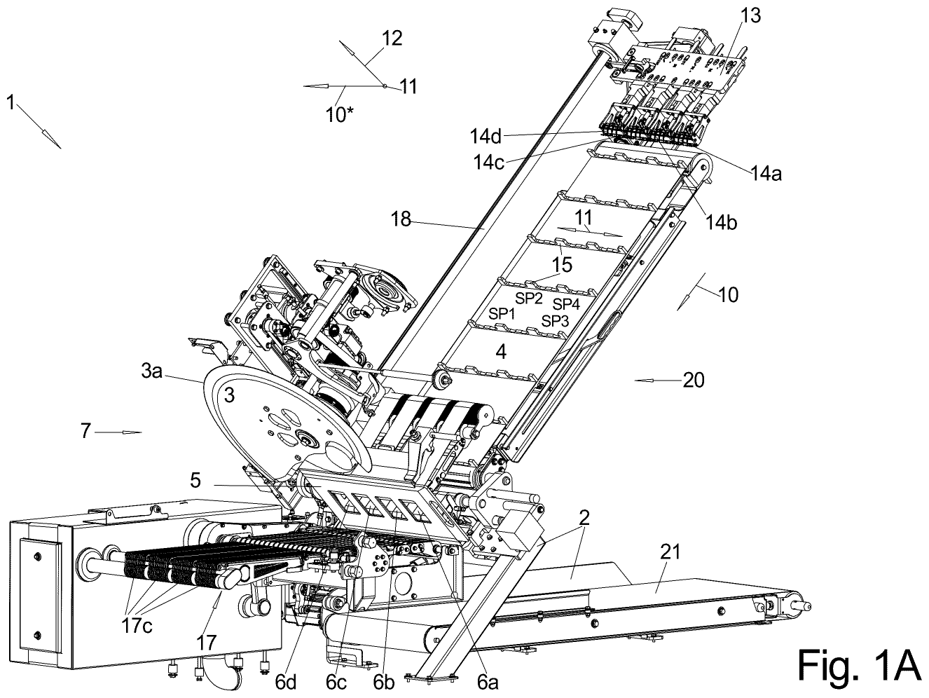

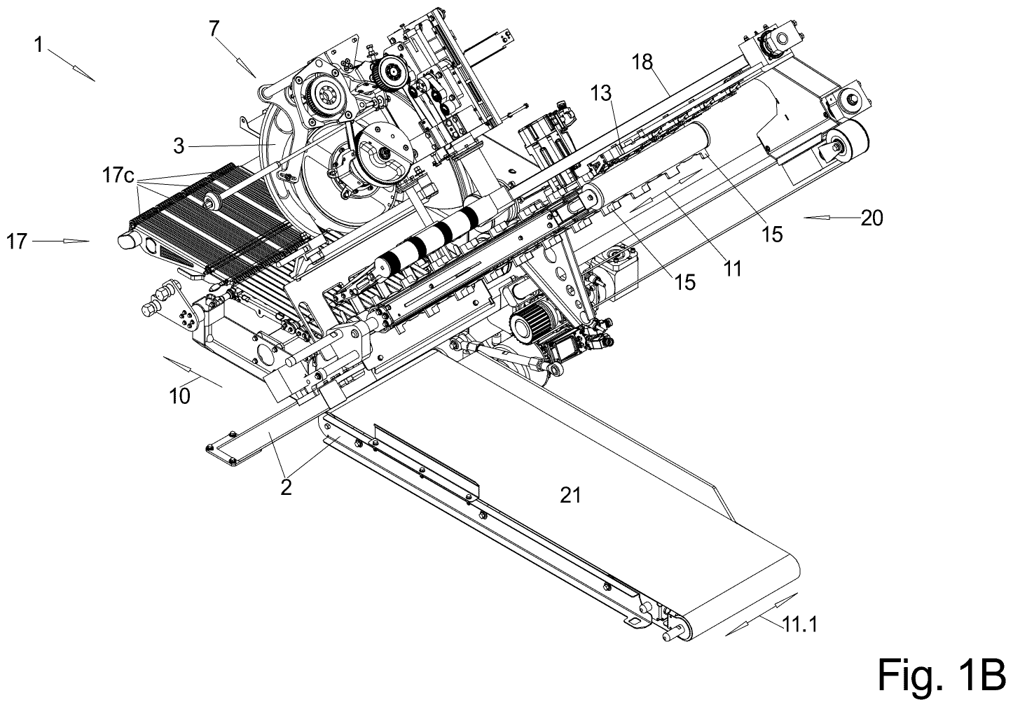

FIGS. 1A and 1B show different perspective views of a multi-lane slicer 1 for simultaneously slicing a plurality of slicing products K next to one another in each case on one lane SP1 to SP4 and for laying out shingled portions P each of a number of slices S, with a general passage direction 10* through the slicer 1 of right to left.

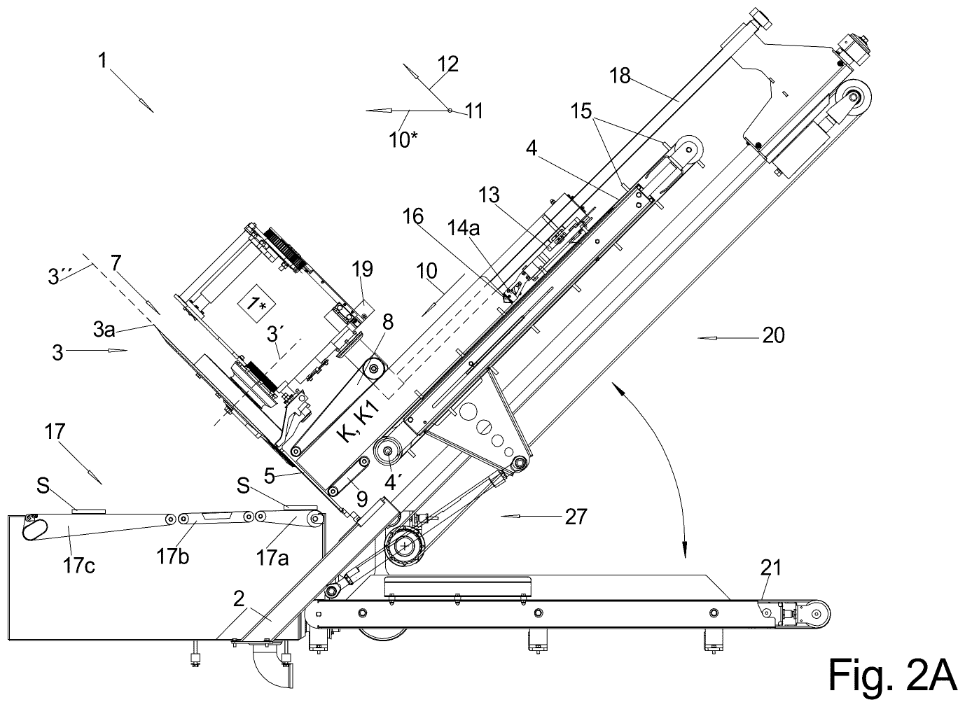

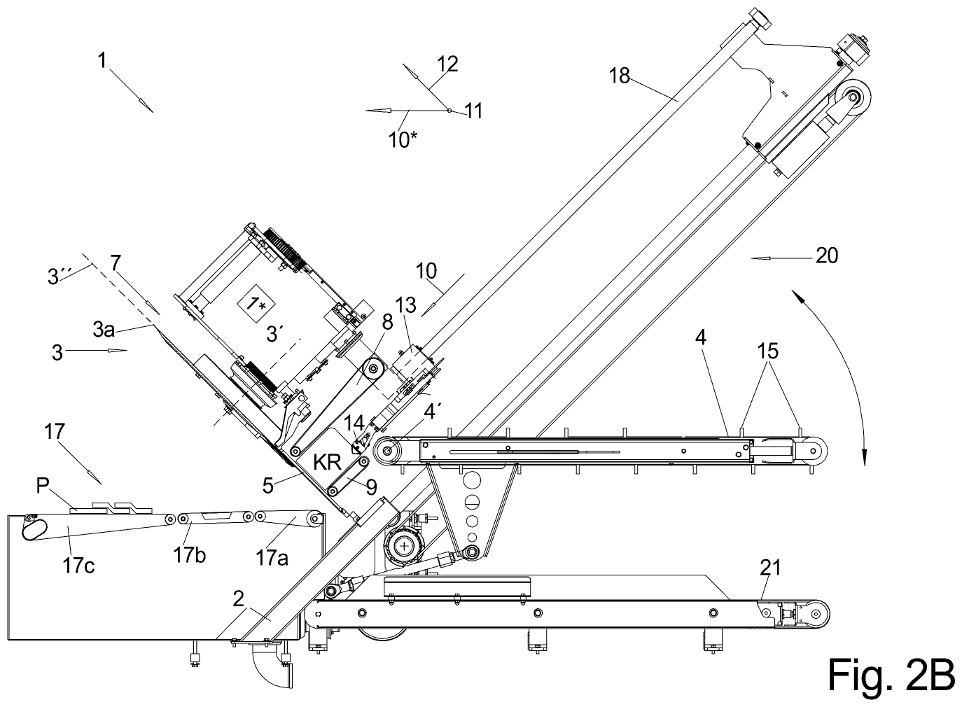

FIG. 2A shows a side view of this slicer 1 with inserted slicing product K but omitting covers and other parts not relevant to the disclosure, which would, like all the other units, be attached to the base frame 2, such that the functional parts, especially the conveyor belts, are more readily visible. The lengthwise direction 10 is the direction in which the slicing product K is fed to the cutting unit 7 and thus also the lengthwise direction of the slicing product K lying in the slicer 1.

It is clear that the basic structure of a slicer 1 according to the prior art consists in this feed unit 20 feeding multiple, in this case four, slicing products K lying next to one another across the feed 10 direction on a feed conveyor 4 and with spacers 15 of the feed conveyor 4 therebetween to a cutting unit 7 with a blade 3, for instance an involute blade 3, rotating about a blade axis 3′, in each case one slice S being severed from the front ends of each of said slicing products K by the rotating blade 3 with its cutting edge 3a in one operation, i.e., virtually simultaneously.

For slicing of the slicing product K, the feed conveyor 4 is located in the slicing position shown in FIGS. 1A-2A and inclined in side view, with its front end (at the cutting end) low and the rear end high. From this slicing position, it may be folded down about a pivot axis 20′ extending in the width direction thereof (the first transverse direction 11), located in the vicinity of the cutting unit 7 into an approximately horizontal loading position, as shown in FIG. 2B.

The rear end of each slicing product K lying in the feed unit 20 is held, according to FIG. 2A, in each case by a gripper 14a-d, in form-fitting manner with the assistance of gripper claws 16. These grippers 14a-14d, which can be activated and deactivated in terms of the position of the gripper claws 16, are attached to a common gripper carriage 13, which can be guided along a gripper guide 18 in the feed direction 10.

In this case, advance both of the gripper carriage 13 and of the feed conveyor 4 is drivable in controlled manner, wherein, however, the specific rate of advance of the slicing products K is brought about by “top” and “bottom” product guides 8, 9 likewise driven in controlled manner which are applied to the top and bottom of the slicing product K to be sliced in the front end regions thereof close to the cutting unit 7.

| The front ends of the slicing products K are each guided through a product opening 6a-d in a plate-shaped cutting frame 5, wherein the cutting plane 3″, in which the blade 3 rotates with its cutting edge 3a and so severs the part of the slicing product K protruding out of the cutting frame 5 as a slice S, extends directly in front of the front, downwardly inclined end face of the cutting frame 5. The cutting plane 3″ extends perpendicular to the upper run of the feed conveyor 4 and/or is formed by the two transverse directions 11, 12 to the feed direction 10.

In this case, the inner circumference of the product openings 6a-d serves as a counter cutting edge for the cutting edge 3a of the blade 3.

Since both product guides 8, 9 are drivable in controlled manner, in particular mutually independently and/or possibly separately for each lane SP1 to SP4, they determine the rate of advance (which may be continuous or clocked) of the slicing product K through the cutting frame 5.

The top product guide 8 is displaceable in the second transverse direction 12, which extends perpendicular to the upper run of the feed conveyor 4, for adaptation to the height H of the slicing product K in this direction. Furthermore, at least one of the product guides 8, 9 may be configured to be pivotable about one of its deflection rollers in order to be able to modify, to a limited degree, the direction of the run of the guide belt thereof resting on the slicing product K.

The slices S, which are inclined in space when severed, drop onto a discharge conveyor device 17 starting below the cutting frame 5 and running in the passage direction 10*. The discharge conveyor device in this case consists of a plurality of discharge conveyor units 17a, b, c arranged one behind the other in the passage direction 10* and with the upper runs of their conveyor belts roughly aligned. The first 17a of the discharge conveyor units in the passage direction 10* may take the form of a portioning belt unit 17a and/or a weighing unit.

The slices S may fall individually and spaced apart in the passage direction 10* onto the portioning belt unit 17a or, if the portioning belt 17a of the discharge conveyor device 17 is appropriately controlled (movement thereof, like almost all the moving parts, being controlled by the controller 1*), form shingled or stacked portions P through stepwise forward or backward movement of the portioning belt 17a. In that regard, as one skilled in the art would understand, the controller 1*, as well an any other unit, machine, apparatus, element, sensor, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such controller, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

Located as a rule below the feed conveyor unit 20 is an approximately horizontally extending residue conveyor 21, which starts with its front end below the cutting frame 5 and directly below or behind the discharge conveyor unit 17 and with its upper run conveys away to the rear residues dropping onto said upper run contrary to the passage direction 10 by way of the drive of one of the discharge conveyors 17.

Slicing product parts KT may be joined together according to the disclosure into a markedly longer or indeed virtually endless slicing product K inside or externally outside the machine before the slicing product is introduced into the machine.

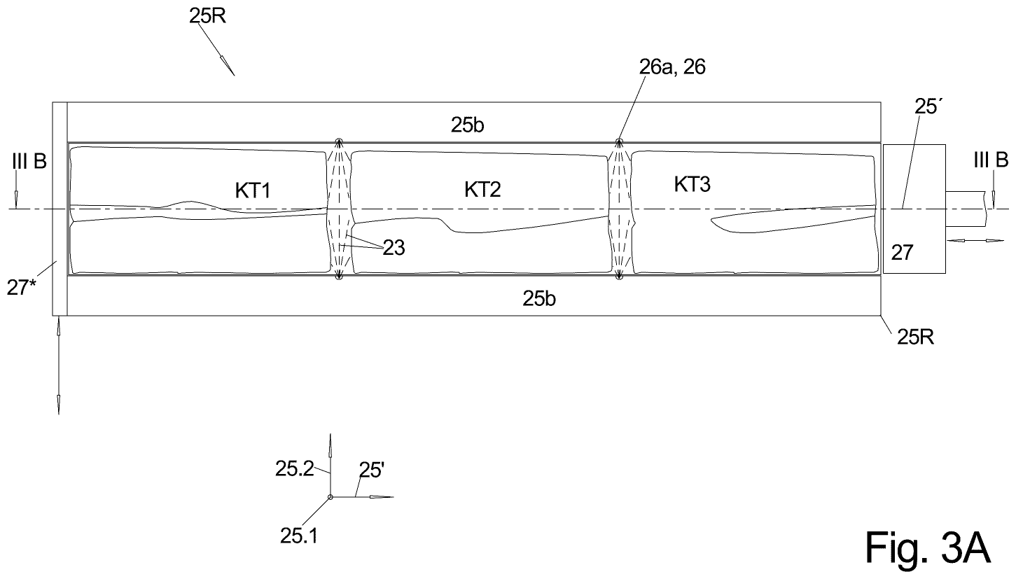

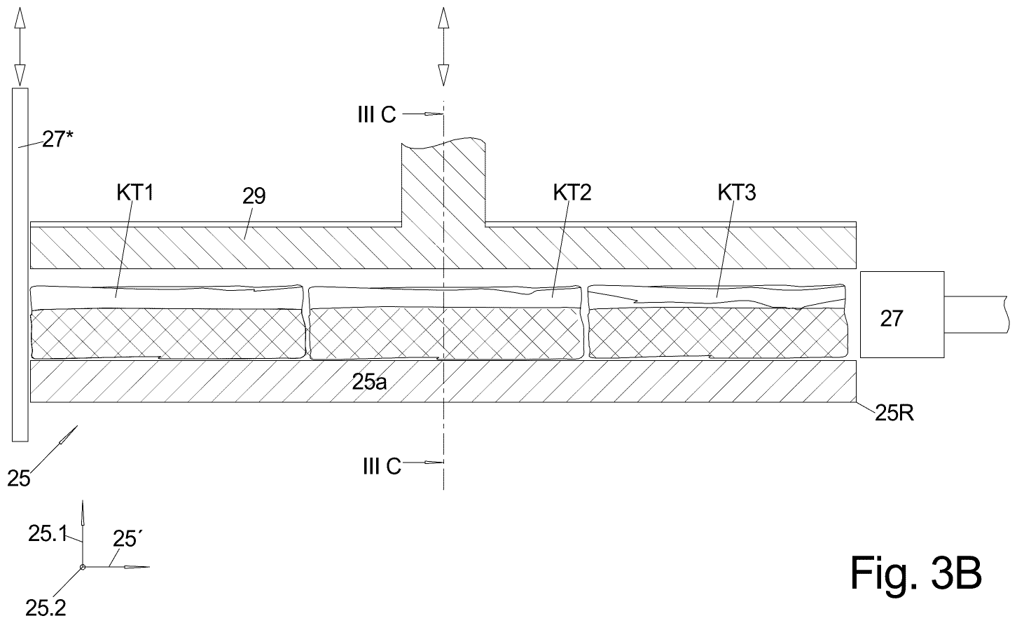

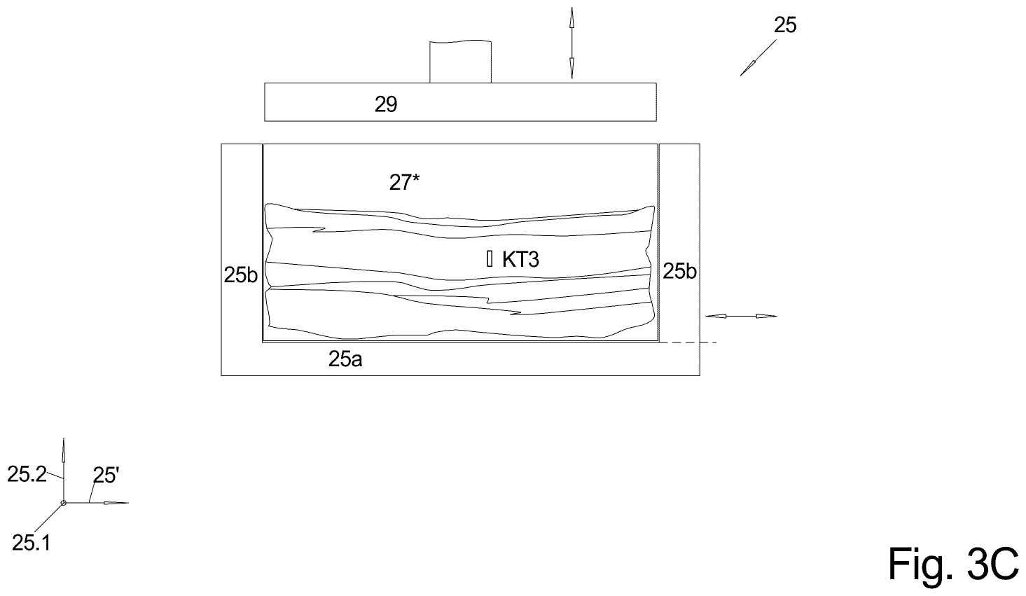

The latter is shown as a first option by FIGS. 3A-C and 4A-C, in which three slicing product parts KT1 to KT3 are arranged one behind the other in the lengthwise direction 25′ and then joined together. The slicing product parts KT1 to KT3 are here arranged with the direction of their greatest extent likewise in this lengthwise direction 25′.

According to these figures, joining takes place in a prepressing device 25, which on the one hand comprises a prepressing trough 25R open at the front and back, i.e., in the lengthwise direction 25′, which prepressing trough 25R is shown alone in FIG. 3A and, according to FIGS. 3A, B, can be closed at one end by a mobile lengthwise stop 27*.

According to FIGS. 3B, C a transverse plunger 29 may descend between the side walls 25b of the prepressing trough 25R for transverse pressing of the slicing product parts KT1 to KT3 located therein and, in the lengthwise direction 25′, a lengthwise plunger 27 of appropriate, in particular variable, cross-section may be introduced between the transverse plunger 29 and the prepressing trough 25R for lengthwise pressing of the three slicing product parts KT1 to KT3.

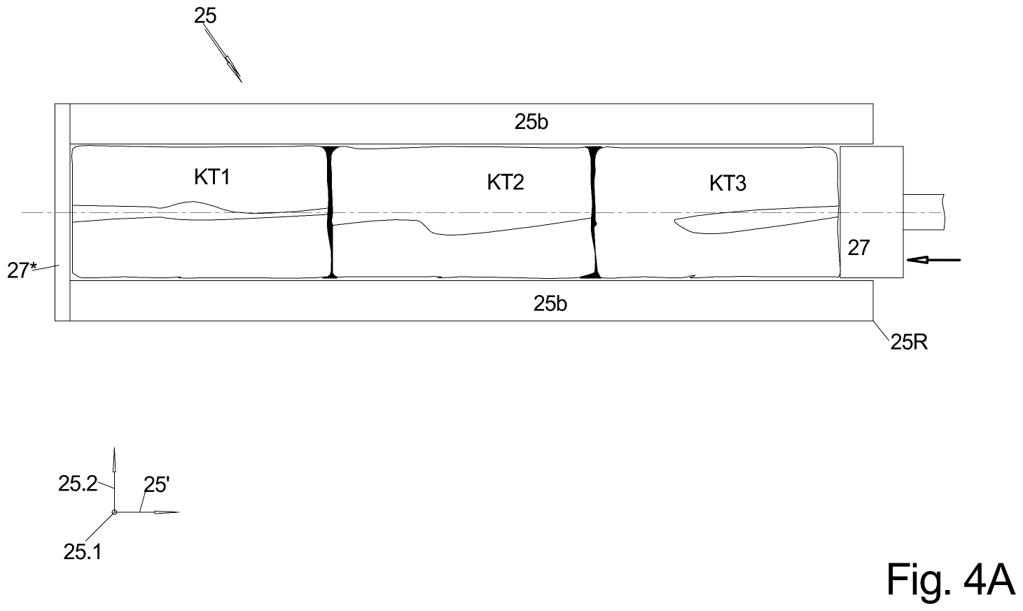

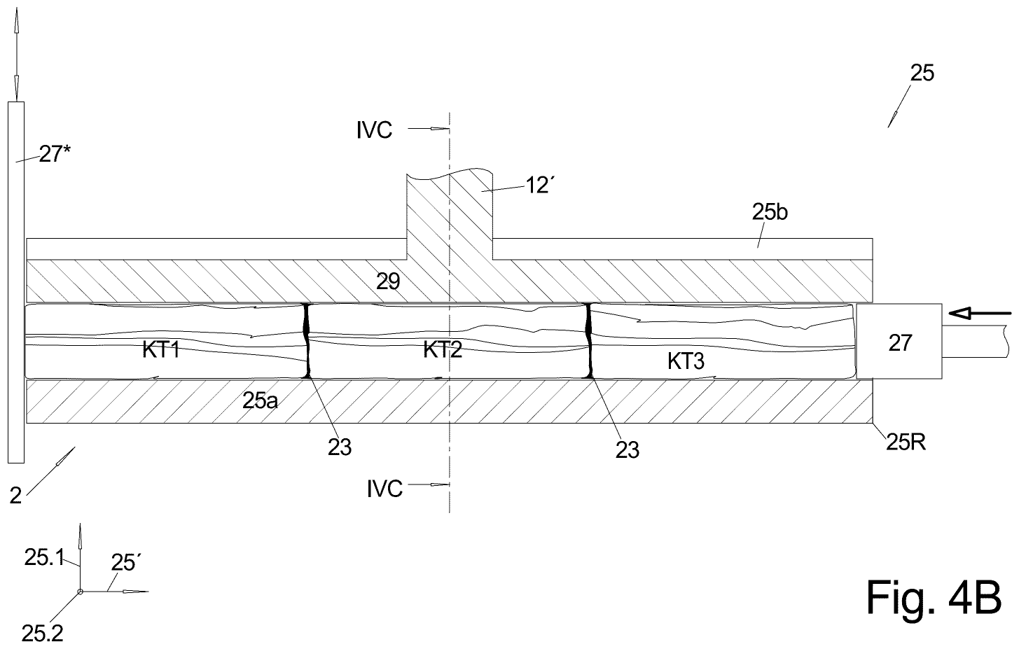

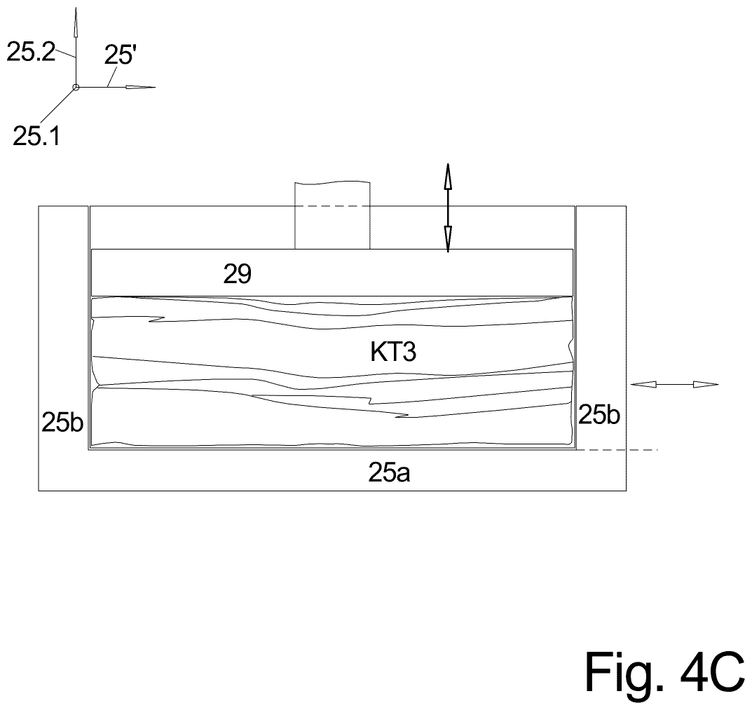

To this end, the free internal width of the prepressing trough 25R should not be too much wider than the width of the inserted slicing product parts KT1, KT2. Alternatively, it is possible, as indicated in FIG. 3C and FIG. 4C, for one of the side walls 25b to be displaceable relative to the other side wall 25b and adjustable in terms of distance from the other side wall, which requires corresponding adaptability of the transverse plunger 29 or transverse plungers 29 of different widths.

The cross-section of the lengthwise plunger 27 should also be variable in the variable transverse directions of the interior of the prepressing trough 25R or lengthwise plungers 27 of different cross-sections should be available.

Conventionally, pressing of slicing products K or slicing product parts KT is carried out individually, so as to provide slicing products K or slicing product parts KT (in particular air-dried ham, which often dishes slightly during drying, or similar slicing products K) which exhibit low levels of uniformity with an approximately identical cross-section transversely of the lengthwise direction.

Since, for slicing, the slicing product K or slicing product part KT is previously frozen, depending on its consistency, the prepressing device 25 may also be used to freeze the slicing product K previously pressed therein, so promoting dimensional stability after pressing and simplifying slicing.

According to the disclosure, however, a plurality of slicing product parts are inserted one behind the other into a prepressing device 25 of appropriate length, in particular if the device is simultaneously a prefreezing device, in order not only to press together the mutually abutting end faces of the slicing product parts KT1 to KT3 on lengthwise pressing using the lengthwise plunger 27 against the lengthwise stop 27*, but also to cause them to freeze together during prefreezing.

If the moisture content (which exits in part from the outer faces during pressing) of the slicing product parts KT is insufficient for this purpose, a corresponding auxiliary freezing agent 23 such as for instance water may be applied to these end faces before pressing and prefreezing starts, preferably as early as in the prepressing trough 25R, using a corresponding injecting element 26, which is merely indicated in FIG. 3A.

The injecting element 26 comprises delivery orifices 26a for the auxiliary freezing agent 23, which may be arranged for example in the side walls 25b of the prepressing trough 25R such that the side walls 25b then constitute components of the injecting element 26. Since, however, the slicing product parts KT1 to KT3 are generally inserted manually into the prepressing trough 25R, wetting of the end face with an auxiliary freezing agent 23 may likewise take place manually, whether using a spray bottle or a brush.

Just as FIGS. 3A, B, C show a plan view, longitudinal section and end view of the loosely inserted but not yet pressed slicing product parts KT1 to KT3, corresponding FIGS. 4A, B, C show the pressed state, in which the auxiliary freezing agent 23, whether liquid naturally contained in the slicing product parts or water which has been additionally introduced, has solidified between the mutually abutting end faces of the slicing product parts KT1 to KT3 simply by cooling.

After sufficient freezing, i.e., freezing to a predetermined depth from the outer face into the slicing product parts, the slicing product K consisting of the three slicing product parts KT1 to KT3 is removed from the prepressing device 25, for example is pushed out using the lengthwise plunger 27 through the opposing, opened end face, and placed onto the feed unit 20, for instance the feed belt 4, irrespective of whether this is adjustable in inclination, as described in relation to FIGS. 1A to 2B, or is at a fixed inclination, which may also be zero.

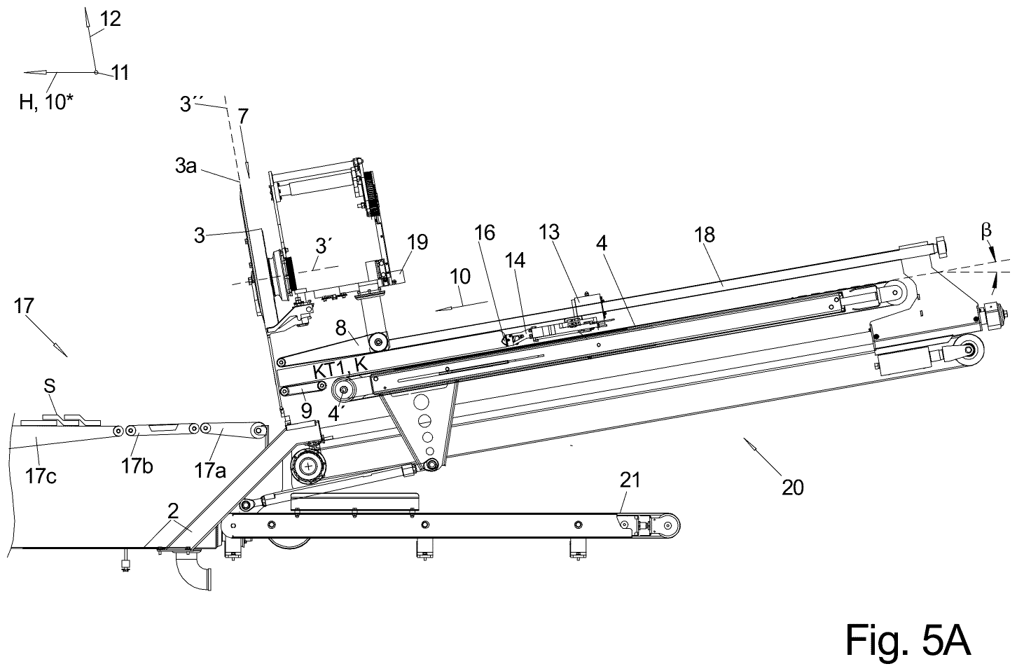

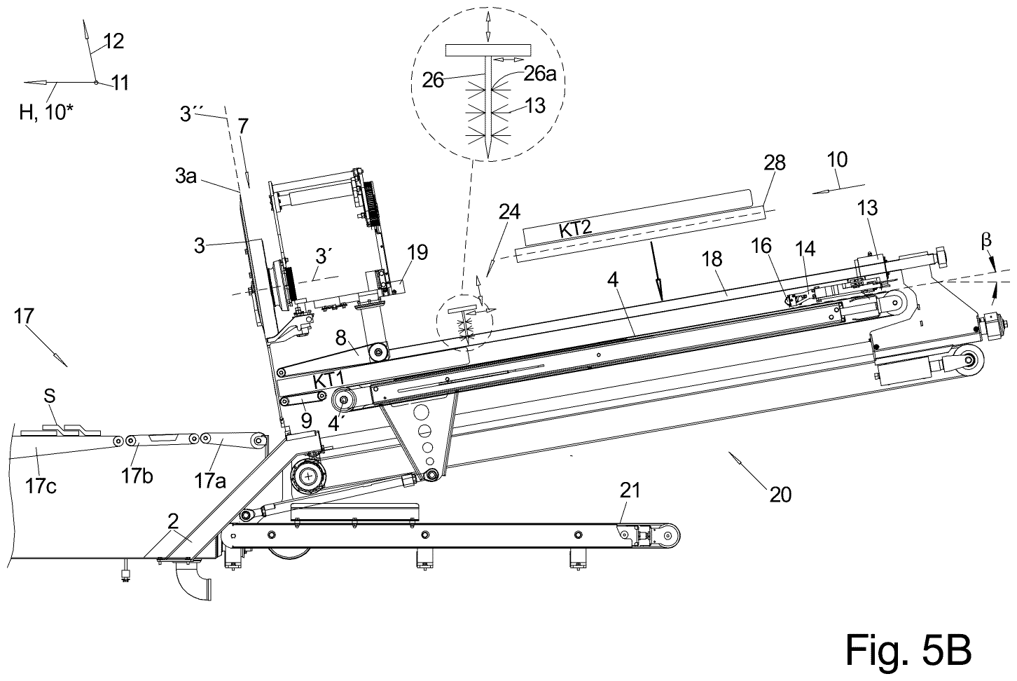

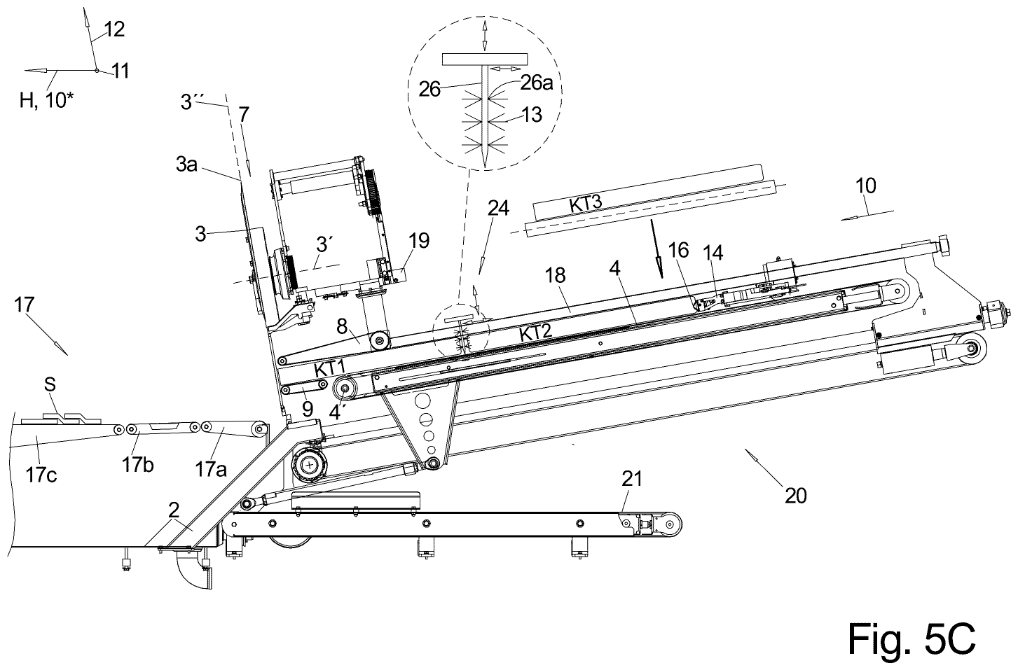

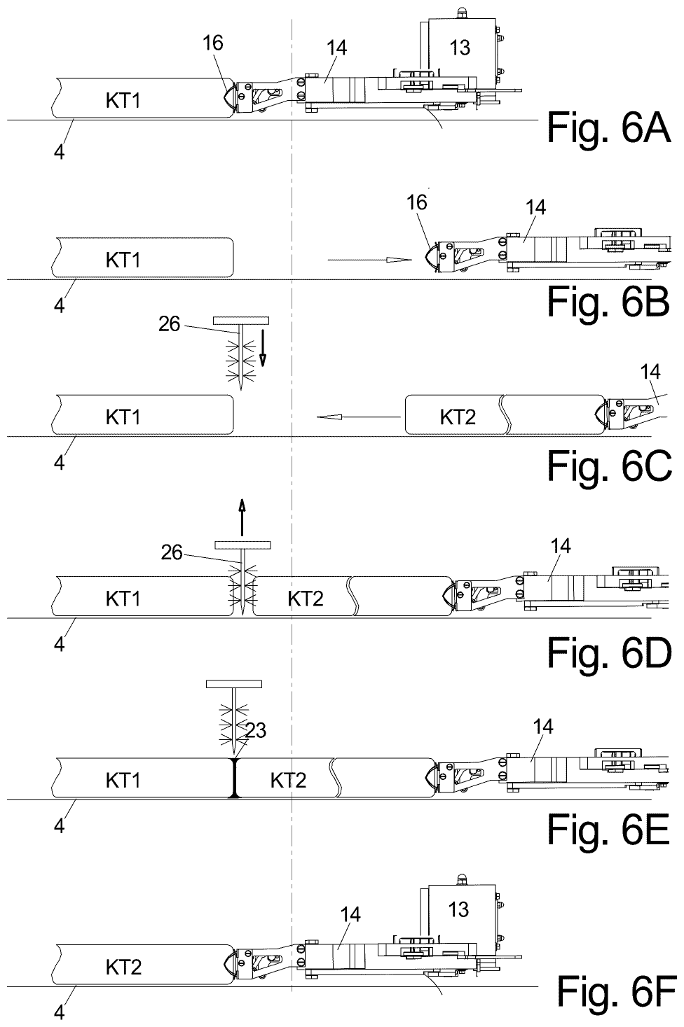

Instead of assembling finite slicing products K from a limited number of slicing product parts KT outside the cutting machine 1, the second option consists in constantly extending the rear of the slicing part provided for slicing purposes with new slicing product parts KT within the machine 1 and thereby having available a virtually endless slicing product K, as shown in FIGS. 5A, B, C in general overview and in greater detail in the enlarged details shown in FIGS. 6A to 6E.

FIG. 5A shows a side view of a cutting machine 1 with a feed unit 20 directed inclined downward toward the cutting unit 7 when in cutting operation, but at significantly less of an inclination, of only around 10°, relative to horizontal than in the case of a conventional slicer according to FIG. 2B. Otherwise, however, this slicer corresponds to the known construction according to FIGS. 1A to 2B irrespective of whether the inclination of the feed unit 20, in particular of the upper run of the feed belt 4, is fixed or variable according to FIGS. 5A-C.

In FIG. 5A, a slicing product part KT1 held, as is conventional, at the rear end by a gripper 14 is sliced, wherein in this case too the cutting machine 1 may be a multi-lane cutting machine.

In FIG. 5B, the gripper 14 is detached from this slicing product part KT1 and retracted into its rearmost starting position, such that the next slicing product part KT2 delivered by a supply unit 28, in general a supply belt 28, can be introduced between the slicing product part KT1 gripped for slicing and the gripper 14 and deposited on the upper run of the feed belt 4.

In FIG. 5C, the gripper 14 has gripped the rear end of this new slicing product part KT2 and is moving it in controlled manner in the feed direction 10 toward the rear end of the slicing product KT1, which is in particular being sliced and which is now held only between the top and bottom product guides 8, 9 and moved by them.

A joining device 24 with an injecting element 26, in this case for example a plate-shaped injecting element 26 whose main plane extends in the two transverse directions to the feed direction 10, is arranged between the slicing product parts KT1, KT2, such that only the narrow side thereof is visible.

This injecting element 26 is controlled to move in one of the transverse directions to the feed direction 10 and may be inserted between the two end faces of the slicing product parts KT1 and KT2 (in particular also while the slicing product part KT1 is being further sliced, i.e., is moving forward in the feed direction 10) in order there to deliver an auxiliary freezing agent 23, for example water, before the rear slicing product KT2 contacts the rear end face of the front slicing product part KT1 after withdrawal of the injecting element 26 and these for example prefrozen slicing product parts KT1, KT2 join together by freezing. This is achieved by temperature equalization between the small amount of injected water (over 0° C.) and the adjoining frozen end regions (below 0° C.), said temperature equalization leading, due to the small amount of water relative to the mass of the frozen end regions, to the equalized temperature and thus also that of the water falling below 0° C. and the water thus freezing and joining the two end regions together.

The next slicing product part KT3 may already be being held ready on the supply belt 28.

The joining sequence for joining a new slicing product part to a previous slicing product part KT1 already located in the slicer 1 and gripped for slicing is shown in FIGS. 6A-E in the form of details enlarged relative to FIGS. 5A, B, C and without the inclination of the feed direction 10 shown therein.

FIG. 6A is an enlarged view of the situation of FIG. 5A, in which the slicing product part KT1 already being sliced is held at its rear end by its gripper 14.

FIG. 6B shows the situation after the gripper 14 has released the slicing product part KT1 and withdrawn into its rear starting position, as depicted in FIG. 5B.

FIG. 6C shows the approach of the front end of the next, new slicing product part KT2 deposited on the feed belt 4 behind the slicing product part KT1 and already gripped and held at the rear end by the gripper 14.

FIG. 6D shows that the joining device 24, in particular the injecting element 26 thereof, depicted in FIG. 6A-C as outside the movement path of the slicing product parts, namely thereabove, is now inserted between the still spaced and mutually facing end faces of the slicing product parts KT1 and KT2 and outputs an auxiliary freezing agent 23 via corresponding delivery orifices 26a onto these end faces.

FIG. 6E shows the end faces, which have been moved against one another by the gripper 14 after removal of the injecting element 26 out of the movement path of the slicing product parts, with the layer, for example of the auxiliary freezing agent 23, located therebetween and now frozen.

In the meantime, the slicing product, here KT1, in the process of being sliced, preferably moves (omitted from FIGS. 6A-F for reasons of clarity) onward in the feed direction 10, and this movement continues until it has been completely sliced up, the joined-on slicing product part KT2 then being sliced. The slices S produced from the joint region 30, which may for example contain the frozen auxiliary freezing agent 23, are then removed as scrap and not put to further use.

After further slicing of slicing product part KT2, this finds itself, as shown in FIG. 6F, in the same feed position 10 as previously shown in FIG. 6A for slicing part KT1, and it is therefore possible to start with the next positioning and joining operation.

As described further above, as a rule the slicing product parts KT to be sliced are prefrozen and thus constitute a heat sink, meaning that the freezing-together can be brought about by different auxiliary freezing agents 23:
either water may be sprayed onto the end faces, wherein however the end faces must be brought into contact very rapidly so that the water can only freeze when the two slicing product parts KT1, KT2 are in contact with one another, a process which can, however, be controlled by the temperature of the water,
or just warm air is introduced as auxiliary freezing agent 23, this slightly thawing the outermost layer of the end faces, which are brought into contact with one another before this outermost layer freezes again, whereby the end faces freeze together.

In the case of non-frozen slicing product parts, the auxiliary freezing agent 23 may be a refrigerant, which not only causes the end faces to freeze together but also causes the slicing product parts to freeze to a predetermined depth of said slicing product parts away from the end face, in order to form a heat sink so that the frozen joint is sustained until the joint between the slicing product parts has been sliced.

Instead of being frozen together, non-frozen slicing product parts may also be joined together using an adhesive, preferably a food-safe adhesive, for example a protein, wherein this may likewise be introduced into the gap between the two end faces by an injecting element 26.

Slicing up slicing product parts KT which are not joined together by merely following one another is de facto not possible, since then the end piece of one slicing product part is no longer guided sufficiently well by top and bottom product guides 8, 9 and is cut up in an uncontrolled manner.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for producing shingled or stacked portions from one or more slices severed from a product using a cutting machine including
a cutting unit,
a feed unit for feeding at least one product to the cutting unit, and
a discharge conveyor unit with at least one portioning belt, the method comprising:
joining together mutually facing end faces of a plurality of product parts adjoining one another in a feed direction to form the product; and
slicing one or more slices from the product.

2. The method as claimed in claim 1, wherein said joining comprises freezing or adhesive bonding.

3. The method according to claim 2, wherein
adhesive bonding comprises using a food-safe adhesive present in the product to be sliced
and/or
freezing comprises using cold present in or supplied to a joint region.

4. The method according to claim 3, wherein
for the freezing
cold contained in an at least partly frozen product part is used as the present cold and/or
an auxiliary freezing agent comprising a gas at a temperature below 0° Celsius, or a liquid at a temperature of below 0° Celsius, is supplied as the supplied cold.

5. The method according to claim 1, wherein
the products parts are frozen prior to slicing at least in their outer peripheral region and are sliced in this frozen state and
the end faces of the frozen product parts are thawed by introducing heat in the form of appropriately temperature-controlled air or water, and the end faces are brought into contact with one another and joined together by refreezing
or
the product parts are arranged one behind the other in mutual contact prior to freezing in a prefreezing mold, and frozen together.

6. The method according to claim 1, wherein
joining is carried out in the cutting machine,
by positioning, during slicing of a product, a further product part against a rear end of the product between a product part of the product to be sliced and a further product part to be positioned.

7. The method according to claim 1, wherein
the product parts are joined to form the product before the product is introduced into the cutting machine,
and wherein more than two product parts are arranged one behind the other and joined together.

8. The method according to claim 7, wherein the more than two product parts arranged one behind the other and joined together are joined simultaneously.

9. The method according to claim 1, wherein
the products or product parts are pressed in a lengthwise and/or transverse direction to a cross-section which is constant over its length and predetermined,
during or prior to prefreezing,
the product parts, prior to pressing in a prepressing device, are arranged one behind the other in mutual contact and their end faces are adapted to one another in terms of shape by pressing in the lengthwise direction and are brought into extensive contact with one another and
during subsequent freezing, frozen together in the prepressing device.

10. The method according to claim 1, wherein
at least one of the end faces to be joined together of successive product parts is flattened by severing an end slice prior to joining.

11. The method according to claim 3, wherein
slices which are cut from the joint region and contain constituents of both successive product parts are removed if, during the joining process, a solid or liquid substance which is not a constituent of one of the successive product parts remains at the joint region.

12. A cutting machine for cutting up products into slices and producing shingled or stacked portions from slices, the cutting machine comprising:
a cutting unit,
a feed unit for feeding at least one product to the cutting unit,
a discharge conveyor unit with at least one portioning belt, and
a joining device for joining product parts arranged one behind another in a feed direction.

13. The cutting machine according to claim 12, wherein
the joining device is part of the feed unit and/or is moved together therewith in the feed direction.

14. The cutting machine according to claim 12, wherein
the joing device is part of at least one of a prepressing device and/or prefreezing device.

15. The cutting machine according to claim 12, wherein
the joining device comprises, as part of the feed unit, an injecting element for an adhesive or an auxiliary freezing agent comprising water or a substance with a vaporization temperature of below 0° C.
a combined prepressing and prefreezing device comprises a lengthwise plunger and the injecting element.

16. The cutting machine according to claim 12, wherein
a feed belt of the feed unit has an inclination, and a supply unit comprising a supply belt, for delivering product parts is present upstream in the feed direction.

17. The cutting machine according to claim 12 further comprising a controller for controlling the cutting unit, the feed unit, and/or the discharge conveyor unit.
